(19) United States
(12) Patent Application Publication
(10) Pub. No.: US 2025/0353305 A1
(43) Pub. Date: Nov. 20, 2025

(54) LIQUID CONTAINER AND SYSTEM

(71) Applicant: BROTHER KOGYO KABUSHIKI KAISHA, Nagoya (JP)

(72) Inventors: Masahiro HAYASHI, Anjo (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 19/284,263

(22) Filed: Jul. 29, 2025

Related U.S. Application Data
(63) Continuation of application No. PCT/JP2024/002369, filed on Jan. 26, 2024.

(30) Foreign Application Priority Data
Jan. 31, 2023 (JP) 2023-012483

(51) Int. Cl. B41J 2/175

(52) U.S. Cl. CPC B41J 2/17523

(57) ABSTRACT

A liquid container includes: a body including a port portion defining an opening of a storage chamber configured to store a recording liquid; and a valve located inside the body. The port portion includes a communication port that communicates the storage chamber with outside, the valve is movable in an axial direction in which an axis of the port portion extends, between a close position where the communication port is closed and an open position where the communication port is opened, and a region serving as the communication port in a virtual section orthogonal to the axis is asymmetrical with respect to the axis.

### REFERENCE TO RELATED APPLICATIONS

This is a continuation application of International Application No. PCT/JP2024/002369 filed on Jan. 26, 2024, which claims priority from Japanese Patent Application No. 2023-012483 filed on Jan. 31, 2023. The entire contents of the aforementioned applications are incorporated herein by reference.

### BACKGROUND ART

In a related art, there is known a liquid replenishment container including a container body capable of containing ink, a liquid replenishment nozzle attached to a distal end of the container body, and a valve body that closes an opening of the liquid replenishment nozzle. An air discharge flow path is formed between the valve body and an inner surface on one side of the liquid replenishment nozzle. A liquid replenishment flow path is formed between the valve body and the inner surface on the other side of the liquid replenishment nozzle. At the time of attaching the liquid replenishment container to an ink tank, a liquid supply portion of the ink tank abuts against the valve body, so that the valve body is pressed up to a position where the opening of the liquid replenishment nozzle is opened. Accordingly, ink is injected from the container body into the ink tank through the liquid replenishment flow path, and air flows from the ink tank into the container body through the air discharge flow path. In this way, air-liquid exchange is performed in which the ink and the air move back and forth between the liquid replenishment container and the ink tank, so that the ink is injected from the liquid replenishment container into the ink tank.

In the liquid replenishment container, the valve body has a size to close the opening of the liquid replenishment nozzle, and the air discharge flow path is formed between the valve body and the inner surface of the liquid replenishment nozzle. When the liquid replenishment nozzle is thin, the air discharge flow path is also thin, and the flow of air is likely to stagnate in the air discharge flow path. As a result, the ink is less likely to be smoothly injected from the liquid replenishment container into the ink tank.

### SUMMARY

Therefore, there is a demand for a liquid container and a system that allow smooth air-liquid exchange in which a recording liquid and air move back and forth between the liquid container and a tank.

A liquid container according to the present disclosure includes a body including a port portion defining an opening of a storage chamber configured to store a recording liquid, and a valve located inside the body. The port portion includes a communication port that communicates the storage chamber with outside. The valve is movable in an axial direction in which an axis of the port portion extends, between a close position where the communication port is closed and an open position where the communication port is opened. A region serving as the communication port in a virtual section orthogonal to the axis is asymmetrical with respect to the axis.

A liquid container according to the present disclosure includes a body including a port portion defining an opening of a storage chamber configured to store a recording liquid, and a valve located inside the body. The port portion includes a first communication port and a second communication port that communicate the storage chamber with outside. The valve is movable in an axial direction in which an axis of the port portion extends, between a close position where the first communication port and the second communication port are closed and an open position where the first communication port and the second communication port are opened. A first distance between the second communication port and the axis is larger than a second distance between the first communication port and the axis.

### BRIEF DESCRIPTION OF THE DRAWINGS

FIG. 1A and FIG. 1B are external perspective views of a multi function device 10, in which FIG. 1A illustrates a state where a cover 70 is closed, and FIG. 1B illustrates a state where the cover 70 is opened.

FIG. 2 is a longitudinal sectional view schematically illustrating an internal structure of a printer unit 11.

FIG. 3 is a plan view illustrating arrangement of a carriage 23 and an ink tank 100.

FIG. 4 is a perspective view of an ink tank 100M.

FIG. 5 is a longitudinal sectional view of the ink tank 100M.

FIG. 6 is a top view illustrating a state where a front portion of the ink tank 100 is covered by a holding member 110.

FIG. 7 is a longitudinal sectional view illustrating a state where a tank cap 127 is attached to a cover portion 122.

FIG. 8 is a perspective view of a liquid bottle 80.

FIG. 9 is an exploded perspective view of the liquid bottle 80.

FIG. 10 is a longitudinal sectional view of the liquid bottle 80 in a state where a valve 133 is located at a close position.

FIG. 11 is a diagram illustrating a shape drawn by an inner peripheral surface of an upper end portion of a protrusion 94 in a section obtained by cutting the upper end portion of the protrusion 94 along a horizontal surface.

FIG. 12 is a diagram illustrating that a region 215 serving as a seventh opening 140 and a fifth opening 137 is asymmetric in a left-right direction 9 with respect to an axis A1 in a virtual section orthogonal to the axis A1.

FIG. 13 is a longitudinal sectional view of the liquid bottle 80 in a state where the valve 133 is located at an open position.

FIG. 14 is a longitudinal sectional view illustrating a state where the liquid bottle 80 is attached to the ink tank 100M.

FIG. 15 is a longitudinal sectional view illustrating the liquid bottle 80 according to a modification in which a bottle body 81 and a bottle cap 82 are integrally formed.

FIG. 16 is a diagram illustrating that, in the liquid bottle 80 according to a modification, the region 215 serving as the fifth opening 137, the seventh opening 140, an eighth opening 161, and a ninth opening 162 is asymmetric in the left-right direction 9 with respect to the axis A1 in a virtual section orthogonal to the axis A1.

FIG. 17 is a diagram illustrating that, in the liquid bottle 80 according to another modification, the region 215 serving as an upper end opening 94A is asymmetric in the left-right direction 9 with respect to the axis A1 in a virtual section orthogonal to the axis A1.

FIGS. 18A to 18D are diagrams illustrating a position of a center A2 in an upper end portion of the protrusion 94 in a section obtained by cutting the upper end portion of the protrusion 94 along a horizontal surface in the liquid bottle 80 according to another modification, in which FIG. 18A is a diagram illustrating that the center A2 is located at a center of a circle drawn by an inner peripheral surface of the upper end portion of the protrusion 94 in the section, FIG. 18B is a diagram illustrating that the center A2 is located at a center of an ellipse drawn by the inner peripheral surface of the upper end portion of the protrusion 94, FIG. 18C is a diagram illustrating that the center A2 is located at a center of a virtual circle drawn by the inner peripheral surface of the upper end portion of the protrusion 94, and FIG. 18D is a diagram illustrating that the center A2 is located at an intersection of two diagonal lines of a rectangle drawn by the inner peripheral surface of the upper end portion of the protrusion 94.

### DESCRIPTION

Hereinafter, an embodiment will be described. The embodiment to be described below is merely an example of the present disclosure, and it is needless to say that the embodiment of the present disclosure can be appropriately modified without departing from the gist of the present disclosure. In addition, in the following description, advancement from a start point to an end point of an arrow is expressed as an orientation, and movement on a line connecting the start point and the end point of the arrow is expressed as a direction. That is, the orientation is a component of the direction. An upward orientation and a downward orientation are components of an up-down direction 7 and are opposite orientations. A leftward orientation and a rightward orientation are components of a left-right direction 9 and are opposite orientations. A frontward orientation and a rearward orientation are components of a front-rear direction 8 and are opposite orientations. In the present embodiment, the up-down direction 7 corresponds to a gravity direction, and the front-rear direction 8 and the left-right direction 9 correspond to a horizontal direction.

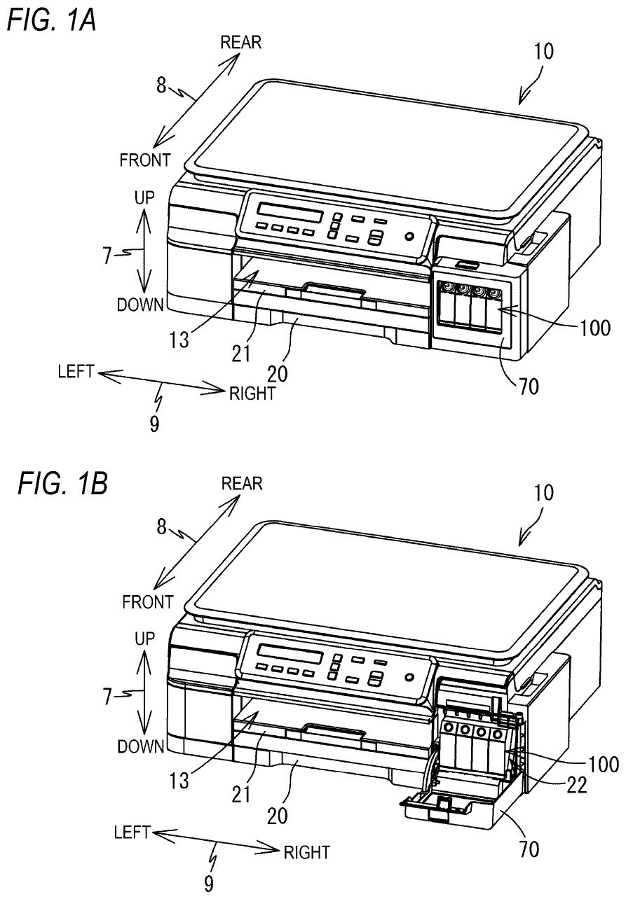

Further, the up-down direction 7 is defined based on a state where a multi function device 10 (example of system) is installed in a usable manner (state of FIGS. 1A and 1B, which may be referred to as “use state”) or a posture (posture of FIGS. 1A and 1B, which may be referred to as “use posture”), the front-rear direction 8 is defined with a side of the multi function device 10 on which an opening 13 is provided as a front side (front surface), and the left-right direction 9 is defined when the multi function device 10 is viewed from the front side (front surface).

### Overall Configuration of Multi Function Device 10

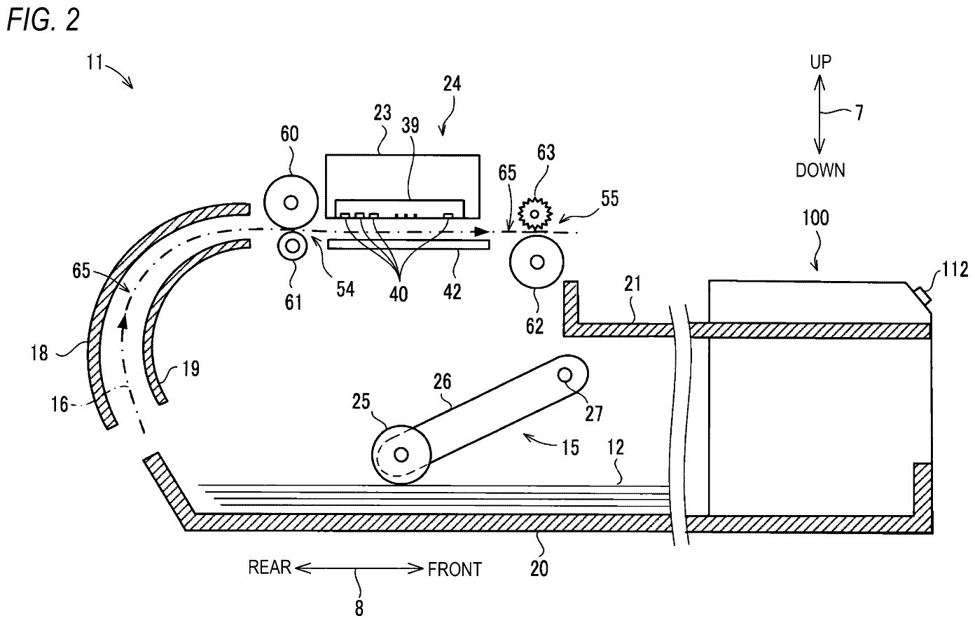

As illustrated in FIGS. 1A and 1B, an outer shape of the multi function device 10 is a substantially rectangular parallelepiped. The multi function device 10 includes a printer unit 11 and a liquid bottle 80 (example of liquid container) described later in a lower portion of a casing. The printer unit 11 records an image on a sheet 12 (see FIG. 2) by an inkjet recording method. As illustrated in FIG. 2, the printer unit 11 includes a feed unit 15, a feed tray 20, a discharge tray 21, a conveying roller part 54, a recording unit 24, a discharge roller part 55, a platen 42, and a tank set 51. The multi function device 10 has various functions such as a facsimile function and a print function.

### Feed Tray 20 and Discharge Tray 21

As illustrated in FIGS. 1A and 1B, the opening 13 is located at a central portion in the left-right direction 9 on the front surface of the multi function device 10. The feed tray 20 moves in the front-rear direction 8 through the opening 13 by a user operation. The feed tray 20 supports a plurality of stacked sheets 12. The discharge tray 21 is located above the feed tray 20. The discharge tray 21 moves in the front-rear direction 8 together with the feed tray 20. The discharge tray 21 supports the sheet 12 discharged by the discharge roller part 55.

### Feed Unit 15

The feed unit 15 feeds the sheet 12 supported by the feed tray 20 to a conveying path 65. As illustrated in FIG. 2, the feed unit 15 includes a feed roller 25, a feed arm 26, and a shaft 27. The feed roller 25 is rotatably supported by a distal end portion of the feed arm 26. The feed roller 25 is rotated by a driving force of a conveying motor (not illustrated) in an orientation in which the sheet 12 is conveyed in a conveying orientation 16. Hereinafter, rotation of the feed roller 25, a conveying roller 60, and a discharge roller 62 in the orientation in which the sheet 12 is conveyed in the conveying orientation 16 is referred to as “forward rotation”. The feed arm 26 is rotatably supported by the shaft 27 supported by a frame of the printer unit 11. The feed arm 26 is biased to pivot toward the feed tray 20 by its own weight or an elastic force of a spring or the like.

### Conveying Path 65

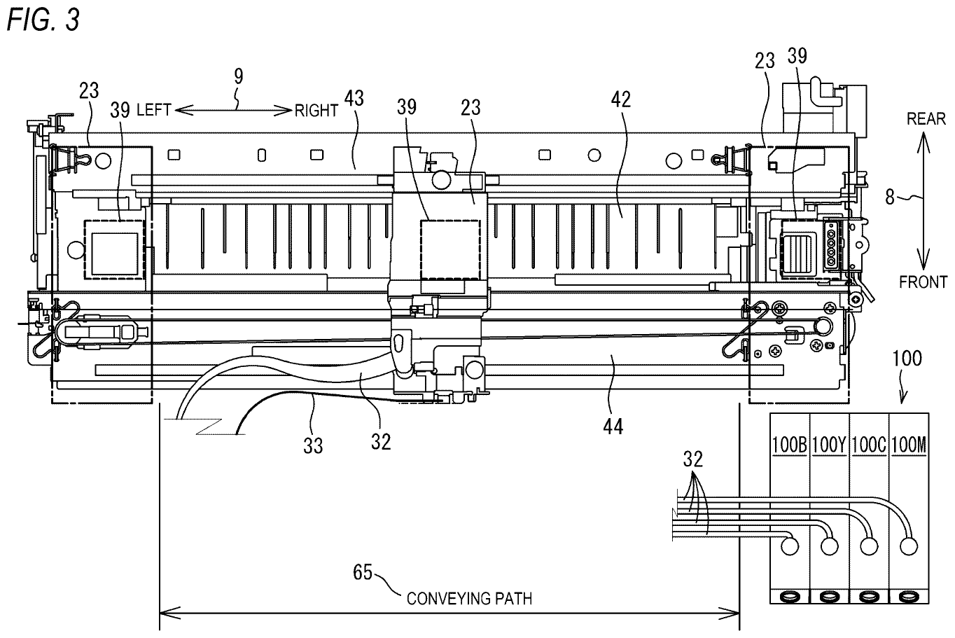

As illustrated in FIG. 2, the conveying path 65 is, for example, a space defined by an outer guide member 18 and an inner guide member 19 facing each other at a predetermined interval inside the printer unit 11. The conveying path 65 extends from a rear end portion of the feed tray 20 to a rear side of the printer unit 11. The conveying path 65 makes a U-turn while extending upward from below on the rear side of the printer unit 11, and reaches the discharge tray 21 through a space between the recording unit 24 and the platen 42. As illustrated in FIGS. 2 and 3, the conveying path 65 between the conveying roller part 54 and the discharge roller part 55 is located at a substantially central portion of the multi function device 10 in the left-right direction 9, and extends in the front-rear direction 8. The conveying orientation 16 of the sheet 12 in the conveying path 65 is indicated by a one-dot chain line arrow in FIG. 2.

### Conveying Roller Part 54

As illustrated in FIG. 2, the conveying roller part 54 is located upstream of the recording unit 24 in the conveying orientation 16. The conveying roller part 54 includes the conveying roller 60 and a pinch roller 61. The conveying roller 60 and the pinch roller 61 face each other in the up-down direction 7. The conveying roller 60 is rotated by the drive transmitted from the conveying motor. The pinch roller 61 rotates following the rotation of the conveying roller 60. When the conveying roller 60 is rotated forward by forward rotation of the conveying motor, the sheet 12 is conveyed in the conveying orientation 16 while being nipped by the conveying roller 60 and the pinch roller 61.

### Discharge Roller Part 55

As illustrated in FIG. 2, the discharge roller part 55 is located downstream of the recording unit 24 in the conveying orientation 16. The discharge roller part 55 includes the discharge roller 62 and a spur 63. The discharge roller 62 and the spur 63 face each other in the up-down direction 7. The discharge roller 62 is rotated by the drive transmitted from the conveying motor. The spur 63 rotates following the rotation of the discharge roller 62. When the discharge roller 62 rotates forward by the forward rotation of the conveying motor, the sheet 12 is conveyed in the conveying orientation 16 while being nipped by the discharge roller 62 and the spur 63.

### Recording Unit 24

As illustrated in FIG. 2, the recording unit 24 is located between the conveying roller part 54 and the discharge roller part 55 in the conveying orientation 16. The recording unit 24 faces the platen 42 in the up-down direction 7 with the conveying path 65 interposed therebetween. The recording unit 24 is located above the conveying path 65 in the up-down direction 7. The recording unit 24 includes a carriage 23 and a recording head 39.

As illustrated in FIG. 3, the carriage 23 is supported by guide rails 43 and 44. The guide rails 43 and 44 are supported by the frame of the printer unit 11. The guide rails 43 and 44 are spaced apart from each other in the front-rear direction 8 and extend in the left-right direction 9. The carriage 23 is coupled to a known belt mechanism provided on the guide rail 44. The belt mechanism is rotated by the drive transmitted from a carriage motor (not illustrated). When the belt mechanism rotates, the carriage 23 moves in the left-right direction 9. A movement range of the carriage 23 is indicated by a one-dot chain line in FIG. 3. The carriage 23 moves to the right and left of the conveying path 65 in the left-right direction 9.

An ink tank 100 and the recording head 39 are connected by an ink tube 32. A control board on which a controller (not illustrated) is mounted and the recording head 39 are electrically connected by a flexible flat cable 33. The ink tube 32 and the flexible flat cable 33 extend from the carriage 23. The ink tube 32 supplies the ink stored in the ink tank 100 to the recording head 39. The flexible flat cable 33 transmits a control signal output from the controller to the recording head 39.

As illustrated in FIG. 2, the recording head 39 is mounted on the carriage 23. A plurality of nozzles 40 are located on a lower surface of the recording head 39. Hereinafter, the lower surface of the recording head 39 where the nozzles 40 are located may be referred to as a “nozzle surface”. The recording head 39 ejects ink (example of recording liquid) as minute ink droplets from the nozzle 40. In the course of movement of the carriage 23, the recording head 39 ejects ink droplets toward the sheet 12 supported by the platen 42. Thus, an image is recorded on the sheet 12.

### Platen 42

As illustrated in FIGS. 2 and 3, the platen 42 is located between the conveying roller part 54 and the discharge roller part 55 in the conveying orientation 16. The platen 42 faces the recording unit 24 in the up-down direction 7. The platen 42 supports, from below, the sheet 12 conveyed by the conveying roller part 54.

### Tank Set 51

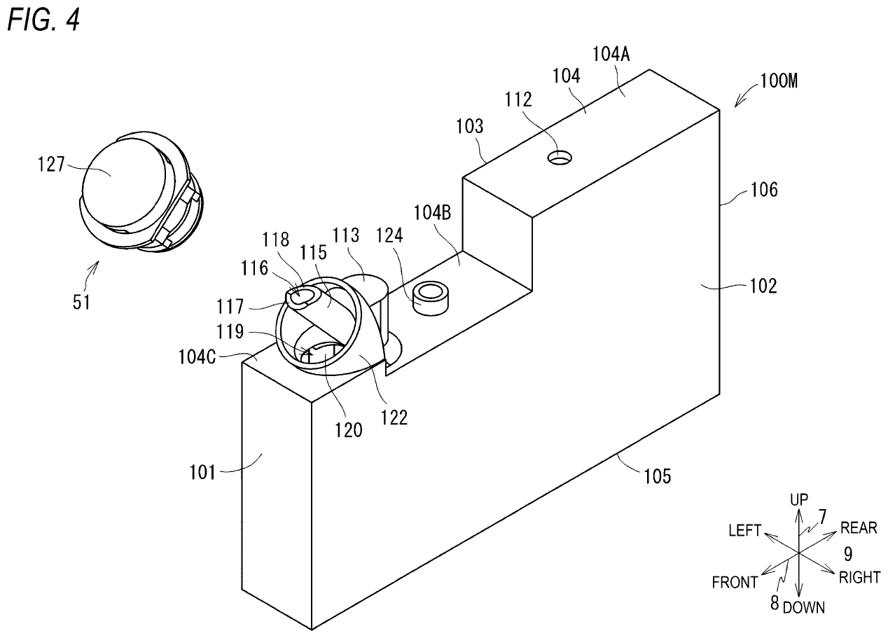

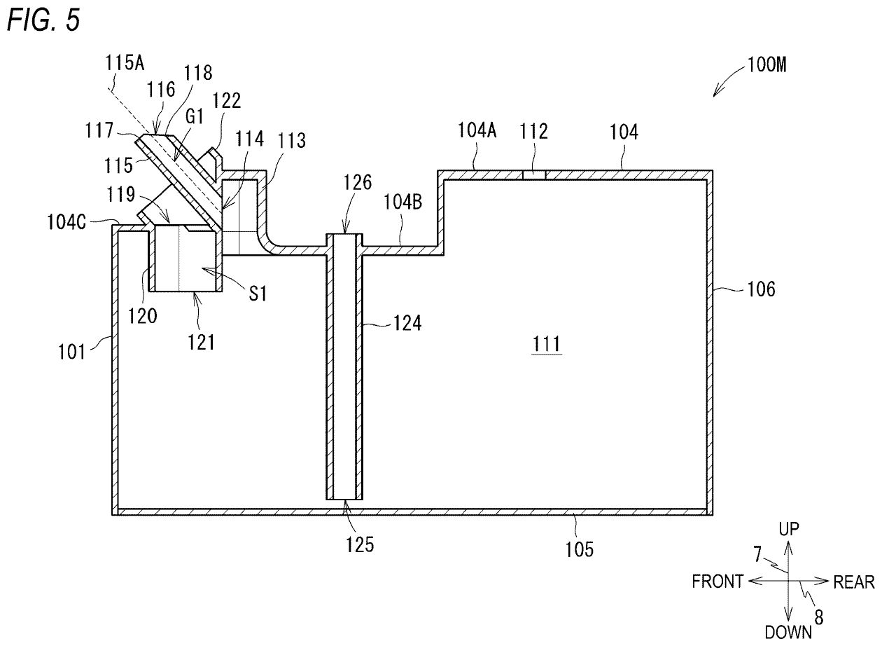

As illustrated in FIGS. 4 to 6, the tank set 51 (example of tank) includes the ink tank 100, a holding member 110, and a tank cap 127. In FIG. 4, the holding member 110 is omitted for simplification of illustration. In FIG. 5, the tank cap 127 is omitted. As illustrated in FIGS. 1A and 1B, the ink tank 100 is located inside the multi function device 10. The ink tank 100 is fixed to the multi function device 10 so as not to be easily detached from the multi function device 10. An opening 22 is formed in the front surface of the casing of the multi function device 10 at the right end in the left-right direction 9. The ink tank 100 is located behind the opening 22. A cover 70 is provided on the opening 22. The cover 70 is rotatable about a rotation axis extending in the left-right direction 9 on the lower end side in the up-down direction 7. The cover 70 rotates between a cover position (see FIG. 1A) where the opening 22 is covered and an expose position (see FIG. 1B) where the opening 22 is exposed to the outside of the multi function device 10.

The ink tank 100 includes four ink tanks 100B, 100Y, 100C, and 100M. The ink tank 100B stores black (B) ink. The ink tank 100Y stores yellow (Y) ink. The ink tank 100C stores cyan (C) ink. The ink tank 100M stores magenta (M) ink. The ink tanks 100B, 100Y, 100C, and 100M have the same configuration. Therefore, hereinafter, the configuration of the ink tank 100M will be described, and the description of the configurations of the other ink tanks 100B, 100Y, and 100C will be omitted.

As illustrated in FIGS. 4 and 5, an outer shape of the ink tank 100M is a substantially rectangular parallelepiped. The ink tank 100 includes a front wall 101, a right wall 102, a left wall 103, an upper wall 104, a lower wall 105, a rear wall 106, a tank-side tube body 115, a third opening 119, a cover portion 122, and an outflow tube 124. The front wall 101, the right wall 102, the left wall 103, the upper wall 104, the lower wall 105, and the rear wall 106 define an ink chamber 111 in which ink is stored. The ink tank 100 is integrally molded by, for example, injection molding a resin material. Among outer walls of the ink tank 100, for example, the lower wall 105 may be another molded article. The front wall 101, the right wall 102, the left wall 103, the upper wall 104, the lower wall 105, and the rear wall 106 have translucency to such an extent that a liquid level of the ink inside the ink tank 100 can be visually recognized from the outside of the ink tank 100.

An upper surface of the upper wall 104 is a horizontal surface extending in the front-rear direction 8 and the left-right direction 9. The upper wall 104 includes a rear upper wall 104A, a middle upper wall 104B, and a front upper wall 104C. The rear upper wall 104A extends from a rear end of the upper wall 104 to a substantially center of the upper wall 104 in the front-rear direction 8. An upper surface of the rear upper wall 104A is located above an upper surface of the middle upper wall 104B and an upper surface of the front upper wall 104C. The rear upper wall 104A has an air communication port 112 that communicates the ink chamber 111 with the outside. The air communication port 112 penetrates the rear upper wall 104A in the up-down direction 7.

The middle upper wall 104B is located between the rear upper wall 104A and the front upper wall 104C in the front-rear direction 8. The middle upper wall 104B is located at a substantially center of the upper wall 104 in the front-rear direction 8. An upper surface of the middle upper wall 104B is located below the upper surface of the rear upper wall 104A. The middle upper wall 104B has a cylindrical upper bulging portion 113 extending in the upward orientation from the upper surface thereof. The upper bulging portion 113 is located at a front end portion of the middle upper wall 104B. An upper end of the upper bulging portion 113 is closed. An internal space of the upper bulging portion 113 is opened in the downward orientation. The upper bulging portion 113 has a first opening 114 that communicates the internal space thereof with the outside. The first opening 114 is circular.

The tank-side tube body 115 (example of second tube body) is connected to the first opening 114. The tank-side tube body 115 is a circular tube extending obliquely in the upward orientation from the first opening 114 along an extending direction intersecting the gravity direction and the horizontal direction. The tank-side tube body 115 is circular when viewed in a tube axis direction. The tank-side tube body 115 has a second opening 116 (example of distal end opening) at the distal end thereof. The second opening 116 is circular. The tank-side tube body 115 communicates the inside and the outside of the ink tank 100. The tank-side tube body 115 defines an air flow path G1 connecting the first opening 114 and the second opening 116. The distal end of the tank-side tube body 115 has a pressing surface 117 and a horizontal surface 118. The pressing surface 117 is a surface parallel to a virtual plane orthogonal to a tube axis 115A of the tank-side tube body 115. The pressing surface 117 is located on the lower side at the distal end of the tank-side tube body 115. The pressing surface 117 is a surface that presses a valve 133 of the liquid bottle 80 when the liquid bottle 80 described later is connected to the ink tank 100M. The horizontal surface 118 is a horizontal surface. The horizontal surface 118 is located on the upper side at the distal end of the tank-side tube body 115. Thus, the second opening 116 is opened in the upward orientation. The horizontal surface 118 may be slightly inclined with respect to the horizontal direction.

The front upper wall 104C extends from a front end of the upper wall 104 to a front end of the middle upper wall 104B. The upper surface of the front upper wall 104C is lower than the upper surface of the rear upper wall 104A and higher than the upper surface of the middle upper wall 104B. The third opening 119 (example of supply port) communicating the ink chamber 111 with the outside is opened in the upper surface of the front upper wall 104C. The third opening 119 penetrates the front upper wall 104C in the up-down direction 7. The third opening 119 is adjacent to the front of the upper bulging portion 113. The third opening 119 is located at a rear end portion of the front upper wall 104C. The third opening 119 is circular. A connection tube body 120 is connected to the third opening 119. The connection tube body 120 is a circular tube extending in the downward orientation from the third opening 119 in the ink chamber 111 along the gravity direction. An inner diameter of the connection tube body 120 is larger than an inner diameter of the tank-side tube body 115. The connection tube body 120 has, at a lower end thereof, a fourth opening 121 that is opened in the downward orientation. The fourth opening 121 is located below the first opening 114. The fourth opening 121 is circular. The connection tube body 120 is a tube body that communicates with the bottle-side tube body 135 of the liquid bottle 80 when the liquid bottle 80 is attached to the ink tank 100M. The connection tube body 120 defines an auxiliary ink flow path S1.

The upper surface of the front upper wall 104C is provided with the cylindrical cover portion 122 that covers the tank-side tube body 115 and a periphery of the third opening 119. The cover portion 122 extends, in parallel with the tank-side tube body 115, in the upward orientation from the front upper wall 104C and the upper bulging portion 113 along the extending direction intersecting the gravity direction and the horizontal direction. The tank-side tube body 115 protrudes in the upward orientation from a distal end of the cover portion 122.

The outflow tube 124 has an outflow port 125 and a connection port 126. The outflow tube 124 is located on the middle upper wall 104B. The outflow tube 124 is located at a substantially center of the middle upper wall 104B in the front-rear direction 8. The outflow tube 124 is a circular tube extending in the up-down direction 7. The outflow tube 124 penetrates the middle upper wall 104B. A lower end of the outflow tube 124 is located in the vicinity of an upper surface of the lower wall 105. An opening at the lower end of the outflow tube 124 is the outflow port 125. An upper end portion of the outflow tube 124 is located outside the ink chamber 111. An opening at the upper end of the outflow tube 124 is the connection port 126. The ink tube 32 is connected to the connection port 126. The ink in the ink chamber 111 is supplied to the recording head 39 via the outflow tube 124 and the ink tube 32 during printing. When the ink in the ink chamber 111 is consumed by ejecting the ink from the recording head 39, air flows into the ink chamber 111 through the air communication port 112.

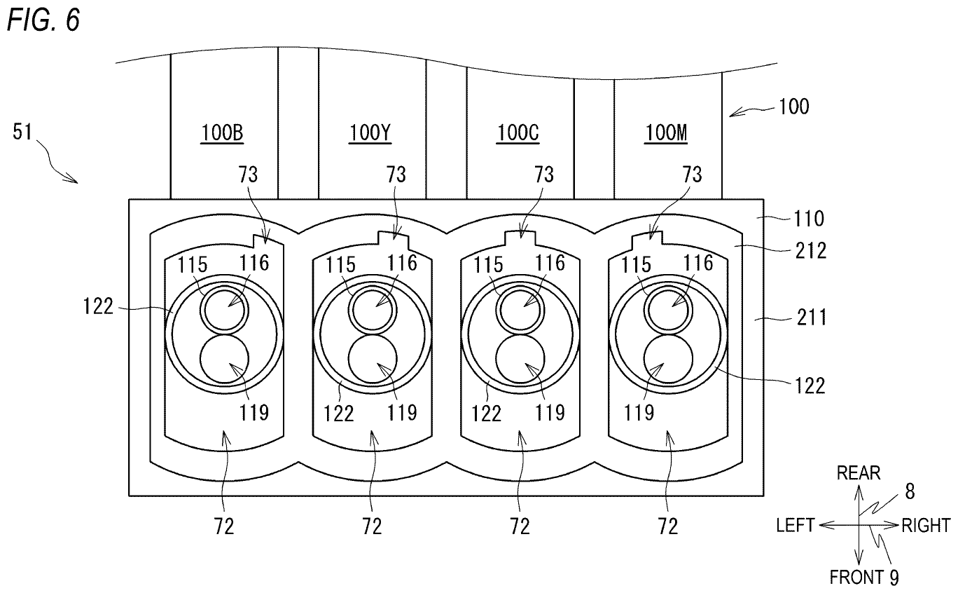

The holding member 110 holds the four ink tanks 100B, 100Y, 100C, and 100M in a state of being aligned in a row along the left-right direction 9 from the front. The holding member 110 covers the front portion of the ink tank 100 in a state of holding the ink tank 100. The holding member 110 has a front wall, an upper wall 211, a left wall, and a right wall. The front wall covers the front of the ink tank 100. As illustrated in FIG. 6, the upper wall 211 covers the ink tank 100 from above. The upper wall 211 has a protruding portion 212 protruding in the upward orientation from an upper surface thereof. The protruding portion 212 protrudes upward from the cover portion 122. The protruding portion 212 has four through holes 72 aligned at an interval in the left-right direction 9. Each of the through holes 72 penetrates the protruding portion 212 in the up-down direction 7. The left wall covers the left side of the ink tank 100. The right wall covers the right side of the ink tank 100. The holding member 110 is attached to the front portion of the ink tank 100 from above the ink tank 100. In a state where the holding member 110 is attached to the front portion of the ink tank 100, the tank-side tube body 115, the third opening 119, and the cover portion 122 of each of the four ink tanks 100B, 100Y, 100C, and 100M are located in the through hole 72. In other words, the through hole 72 is located around the tank-side tube body 115, the third opening 119, and the cover portion 122. The tank-side tube body 115 in each of the four ink tanks 100B, 100Y, 100C, and 100M protrudes to the outside of the holding member 110 through the through hole 72.

As illustrated in FIG. 6, the through hole 72 has a substantially elliptical shape elongated in the front-rear direction 8 when viewed from above. A left inner surface and a right inner surface of the through hole 72 are parallel to each other. The through hole 72 has a key groove 73. The key groove 73 is cut out in a groove shape. Specifically, the key groove 73 is formed by being cut out in a rectangular shape in the rearward orientation from a rear inner surface of the elliptical through hole 72. The inner surface of the through hole 72 has a shape conforming to an outer peripheral surface of a protrusion 94 of the liquid bottle 80 that can be fitted into the through hole 72 when viewed from a direction in which the tank-side tube body 115 extends. The position of the key groove 73 in the left-right direction 9 is different in each through hole 72. The key groove 73 of the leftmost through hole 72 in FIG. 6 is located at the right end portion. The key groove 73 of the second through hole 72 from the left in FIG. 6 is located slightly to the right of the center of the through hole 72 in the left-right direction 9. The key groove 73 of the third through hole 72 from the left in FIG. 6 is located at the center of the through hole 72 in the left-right direction 9. The rightmost key groove 73 in FIG. 6 is located slightly to the left of the center of the through hole 72 in the left-right direction 9.

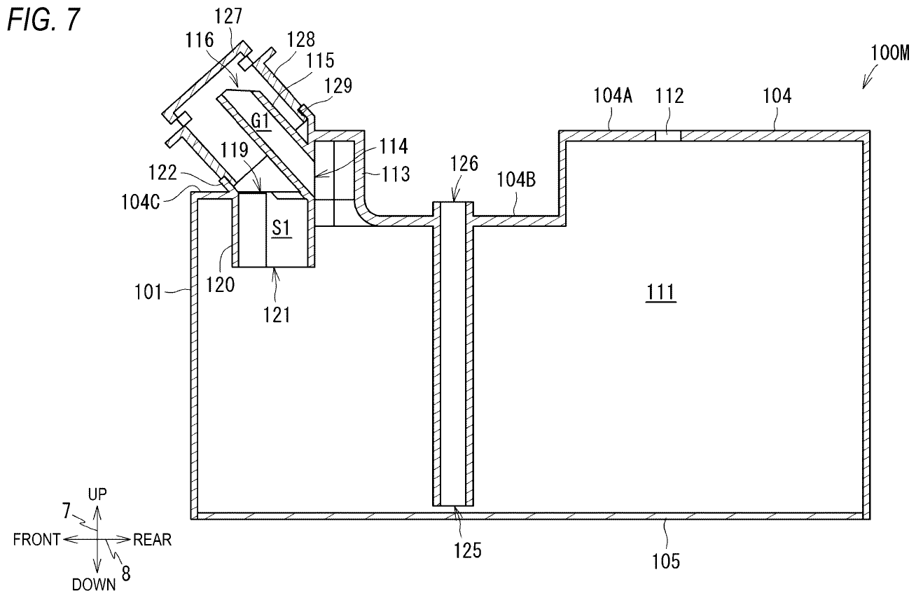

As illustrated in FIG. 7, the tank cap 127 is a cylindrical member having one closed end. The tank cap 127 is attachable to and detachable from the cover portion 122. The tank cap 127 includes a body tubular portion 129 that abuts against the upper end of the cover portion 122, and an insertion tubular portion 130 that is inserted into the cover portion 122. An inner diameter of the body tubular portion 129 is equal to an inner diameter of the insertion tubular portion 130. An outer diameter of the body tubular portion 129 is larger than an outer diameter of the insertion tubular portion 130. The outer diameter of the insertion tubular portion 130 is substantially equal to an inner diameter of the cover portion 122. Thus, the tank cap 127 is attached to the cover portion 122 by press-fitting. The tank cap 127 closes the second opening 116 and the third opening 119 of the tank-side tube body 115 in a state of being attached to the cover portion 122.

### Liquid Bottle 80

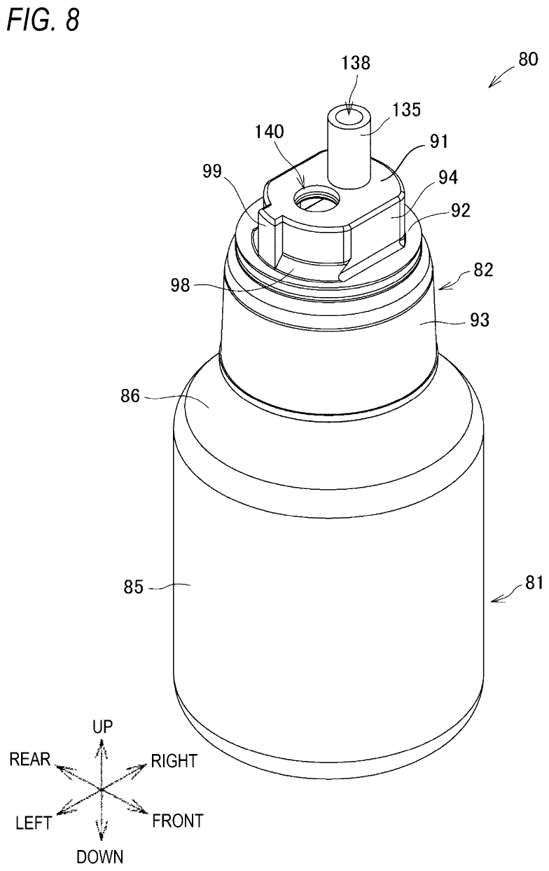

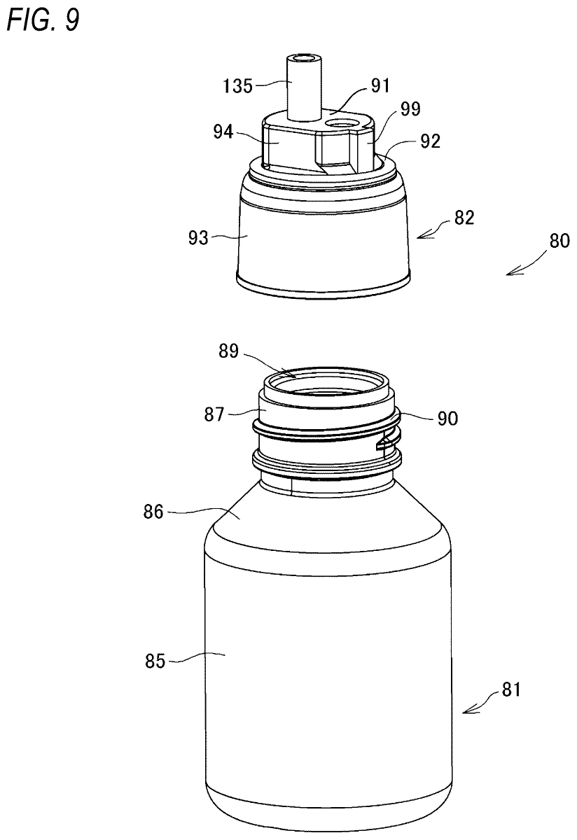

The liquid bottle 80 illustrated in FIGS. 8 to 10 is connected to the ink tank 100M and has a substantially cylindrical shape. The liquid bottle 80 includes a bottle body 81 (example of body) and the valve 133. Hereinafter, in the liquid bottle 80, the up-down direction 7 is defined based on a state where a bottom wall 84 described later is placed on a horizontal surface.

The bottle body 81 includes the bottom wall 84, a first side wall 85, a second side wall 86, a third side wall 87, and a bottle cap 82 (example of port portion, example of container cap). The bottom wall 84 is a substantially circular wall. The first side wall 85 is a cylindrical wall extending in the upward orientation from an outer edge of the bottom wall 84. The second side wall 86 extends in the upward orientation from an upper end of the first side wall 85 while being inclined in a direction in which the bottle body 81 is reduced in diameter. The third side wall 87 is a cylindrical wall extending in the upward orientation from an upper end of the second side wall 86. The third side wall 87 has a male screw 90 on an outer peripheral surface thereof. The third side wall 87 is an example of the port portion and an attachment portion.

A space defined by the bottom wall 84, the first side wall 85, the second side wall 86, and the third side wall 87 is an ink storage chamber 88 (example of storage chamber). Ink is stored in the ink storage chamber 88. The third side wall 87 defines an opening 89 of the ink storage chamber 88. The ink storage chamber 88 communicates with the outside of the bottle body 81 through the opening 89.

The bottle cap 82 is attachable to and detachable from the third side wall 87. The bottle cap 82 includes a bottom wall 92, a fourth side wall 93, and the protrusion 94. The bottom wall 92 is a substantially annular wall. The fourth side wall 93 is a substantially cylindrical wall extending in the downward orientation from an outer peripheral edge of the bottom wall 92. The fourth side wall 93 has a female screw (not illustrated) on an inner peripheral surface thereof. The female screw is screwed with the male screw 90 of the bottle body 81. The bottle cap 82 is attached to the third side wall 87 by screwing the male screw 90 and the female screw.

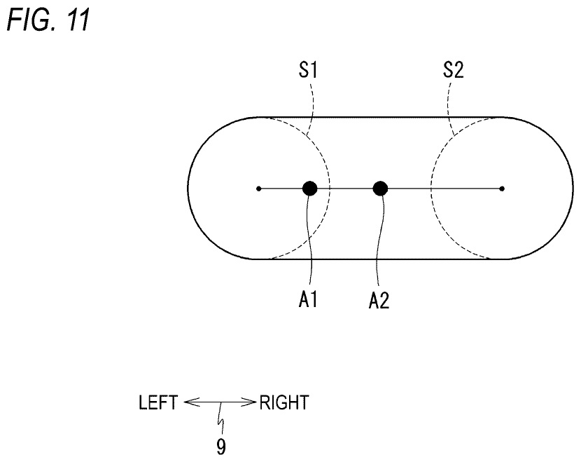

The protrusion 94 is a cylindrical wall protruding in the upward orientation from an inner peripheral edge of the bottom wall 92. An internal space 96 of the protrusion 94 has a substantially elliptical shape when viewed in the up-down direction 7. Specifically, in a section obtained by cutting an upper end portion of the protrusion 94 (portion above inclined portion 98 described later) along a horizontal surface, a shape drawn by an inner peripheral surface of the upper end portion of the protrusion 94 is a shape obtained by connecting two virtual circles S1 and S2 with two parallel tangent lines, as illustrated in FIG. 11. A center A2 of a line segment connecting centers of the two virtual circles S1 and S2 is eccentric with respect to the axis A1 of the third side wall 87 or the fourth side wall 93. The axis A1 is a straight line passing through a center of a circle drawn by an inner peripheral surface of the third side wall 87 in a section obtained by cutting the third side wall 87 or the fourth side wall 93 along a horizontal surface. The eccentricity means that the center A2 is deviated from the axis A1 in a section obtained by cutting the protrusion 94 along a horizontal surface. In other words, the eccentricity means that the center A2 does not coincide with the axis A1 in a section obtained by cutting the protrusion 94 along a horizontal surface. In FIG. 11, the center A2 is located to the right of the axis A1. The rightward orientation is an example of the eccentric orientation.

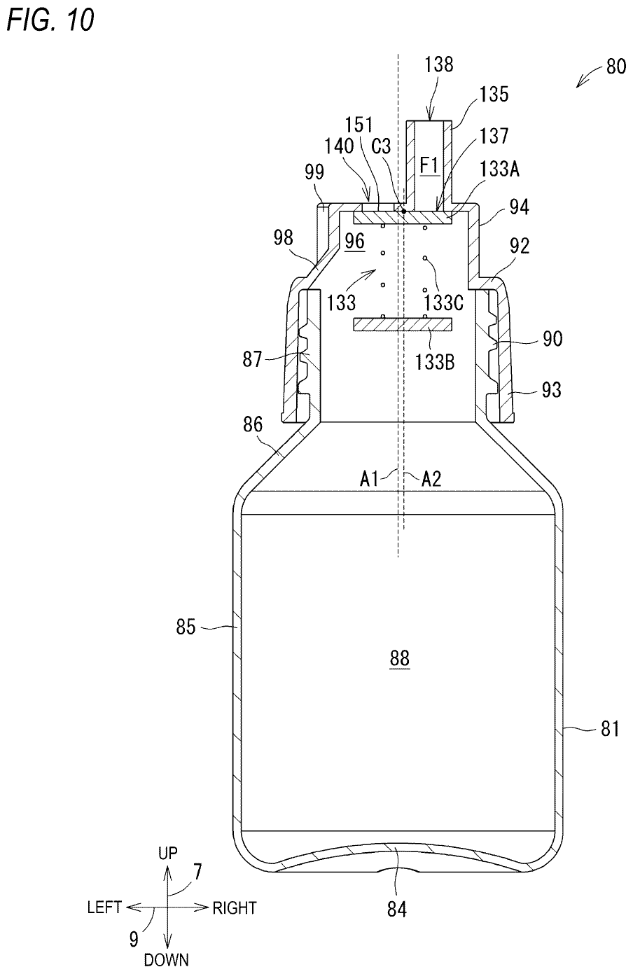

Hereinafter, an orientation opposite to the rightward orientation is referred to as a leftward orientation. The leftward orientation and the rightward orientation are collectively referred to as the left-right direction 9. In the liquid bottle 80, a direction orthogonal to the up-down direction 7 and the left-right direction 9 is referred to as the front-rear direction 8. The upward orientation with respect to the paper surface in FIG. 10 is defined as the frontward orientation, and an orientation opposite to the frontward orientation is defined as the rearward orientation.

The protrusion 94 has an inclined portion 98 on the left side of the lower end portion thereof. When the protrusion 94 is viewed from the front, the inclined portion 98 is inclined such that the internal space 96 of the protrusion 94 extends in the leftward orientation as it goes downward. A space formed by combining the internal space 96 of the protrusion 94 and the ink storage chamber 88 is an example of the inside of the body.

The protrusion 94 includes a key member 99. The outer peripheral surface of the protrusion 94 has a shape conforming to the inner surface of the through hole 72. The protrusion 94 is not rotationally symmetric with respect to the center A2 when viewed in the up-down direction in which the axis A1 extends. The term “rotationally symmetric” means that an object overlaps twice or more when the object is rotated 360 degrees with the center of the object as a rotation axis. For example, in a case where the outer peripheral surface of the protrusion 94 is an equilateral triangle, the protrusion 94 overlaps three times when the protrusion 94 is rotated by 360 degrees with the center A2 as a rotation axis, and thus it can be said that the outer peripheral surface of the protrusion 94 is rotationally symmetrical with respect to the center A2 of the protrusion 94. In the present embodiment, the protrusion 94 overlaps only once when the protrusion 94 is rotated by 360 degrees with the center A2 as the rotation axis, and thus the outer peripheral surface of the protrusion 94 is not rotationally symmetric with respect to a center C1. Therefore, the orientation in which the protrusion 94 can be fitted into the through hole 72 is determined to be one. The outer peripheral surface of the protrusion 94 has a shape in which the shape of the key member 99 is combined with a substantially elliptical shape elongated in the left-right direction 9 when viewed from above. The front side and the rear side of the outer peripheral surface of the protrusion 94 have a planar shape extending in the up-down direction 7 and the left-right direction 9. The left and right sides of the outer peripheral surface of the protrusion 94 are curved surfaces bulging outward in the left-right direction 9.

The key member 99 protrudes in an orientation intersecting the up-down direction in which the axis A1 extends. The key member 99 extends in the leftward orientation from a left portion of the substantially elliptical outer peripheral surface. The key member 99 is located slightly behind the center of the protrusion 94 in the front-rear direction 8. The key member 99 extends from the lower end to the upper end of the protrusion 94. A protruding end of the key member 99 is located to the right of the outer peripheral edge of the bottom wall 92. The key member 99 has a shape that can be fitted into the key groove 73 from above. The key member 99 has a rectangular shape when viewed from above.

The protrusion 94 has a fifth opening 137 and a seventh opening 140. The protrusion 94 has an upper end wall 91 that separates the internal space 96 of the protrusion 94 from the outside. The fifth opening 137 (example of second communication port) and the seventh opening 140 (example of first communication port) are opened in the upper end wall 91 of the protrusion 94. The fifth opening 137 and the seventh opening 140 communicate the internal space 96 of the protrusion 94 with the outside. The fifth opening 137 and the seventh opening 140 are circular. The fifth opening 137 is located to the right of the axis A1. The seventh opening 140 is located to the left of the axis A1.

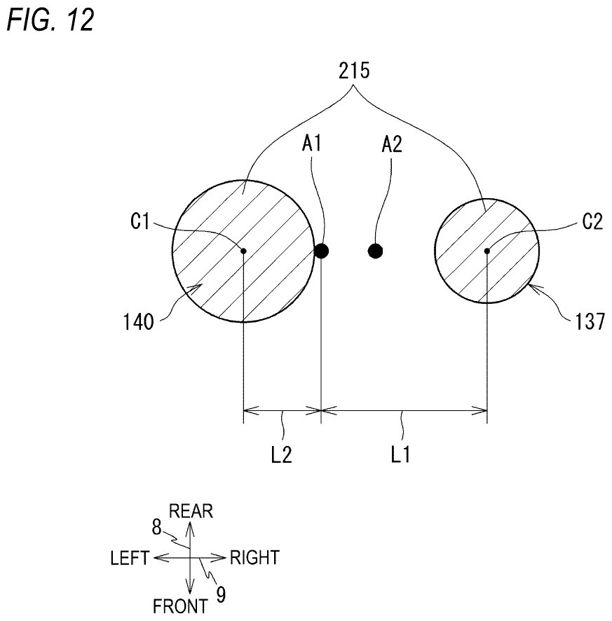

As illustrated in FIG. 12, a distance L1 in the left-right direction 9 between a center C2 of the fifth opening 137 and the axis A1 is larger than a distance L2 in the left-right direction 9 between the center C1 of the seventh opening 140 and the axis A1 in a virtual section orthogonal to the axis A1 in the upper end wall 91 of the protrusion 94. The center C2 is a position where radial distances from an inner surface of the fifth opening 137 are equal. The center C1 is a position where radial distances from an inner surface of the seventh opening 140 are equal. Since the distance L1 is larger than the distance L2, a region 215 serving as the seventh opening 140 and the fifth opening 137 in the virtual section is asymmetric in the left-right direction 9 with respect to the axis A1. In other words, the region 215 is deviated from the axis A1 in an orientation (rightward orientation) toward a position farthest from the axis A1 (right end of fifth opening 137). In the virtual section, the region 215 serving as the seventh opening 140 and the fifth opening 137 is eccentric in the rightward orientation with respect to the axis A1. The right end of the fifth opening 137 is an example of a position farthest from an axis in a region serving as a communication port in a virtual section orthogonal to the axis of the port portion. The rightward orientation is an example of the eccentric orientation. The distance L1 is an example of a first distance. The distance L2 is an example of a second distance.

The protrusion 94 has a bottle-side tube body 135 (example of first tube body). The bottle-side tube body 135 is connected to the fifth opening 137. The bottle-side tube body 135 is a circular tube extending in the upward orientation from the fifth opening 137. An upper end of the bottle-side tube body 135 has a sixth opening 138 that is opened in the upward orientation. The bottle-side tube body 135 defines an ink flow path F1 connecting the fifth opening 137 and the sixth opening 138. A diameter of the ink flow path F1 is equal to a diameter of the air flow path G1 defined by the tank-side tube body 115. The diameter of the ink flow path F1 may not be equal to the diameter of the air flow path G1.

The valve 133 is located inside the bottle body 81. The valve 133 is located in the internal space 96 of the protrusion 94. The valve 133 includes a valve body 133A, a valve seat 133B, and a coil spring 133C. The valve body 133A has a flat plate shape extending in the front-rear direction 8 and the left-right direction 9. The valve body 133A has a substantially elliptical shape along the inner surface of the protrusion 94 when viewed in the up-down direction 7. An upper surface 151 of the valve body 133A abuts against a lower surface of the upper end wall 91 of the protrusion 94. A length of the valve body 133A in the left-right direction 9 is a length for closing the fifth opening 137 and the seventh opening 140. The length of the valve body 133A in the left-right direction 9 is smaller than the inner diameter of the protrusion 94. A center C3 of the upper surface 151 of the valve body 133A in the left-right direction 9 is located to the right of the axis A1. That is, the upper surface 151 of the valve body 133A is eccentric in the rightward orientation with respect to the axis A1. In the present embodiment, the center C3 of the upper surface 151 of the valve body 133A in the left-right direction 9 coincides with the center A2. The upper surface 151 of the valve body 133A is an example of a surface. The length of the valve body 133A in the front-rear direction 8 is a length at which a front end and a rear end of the valve body 133A slightly come into contact with the inner surface of the protrusion 94. The valve body 133A is movable in the up-down direction 7 along the inner surface of the protrusion 94.

The valve seat 133B is located below the valve body 133A. The valve seat 133B has a flat plate shape extending in the front-rear direction 8 and the left-right direction 9. The valve seat 133B is fixed to the inner surface of the protrusion 94 in the front-rear direction 8. The coil spring 133C is located between the valve body 133A and the valve seat 133B. The coil spring 133C is compressible in the up-down direction 7. The coil spring 133C is supported on an upper surface of the valve seat 133B. The coil spring 133C biases the valve body 133A in the upward orientation. Accordingly, the coil spring 133C presses the upper surface 151 of the valve body 133A against the lower surface of the upper end wall 91 of the protrusion 94.

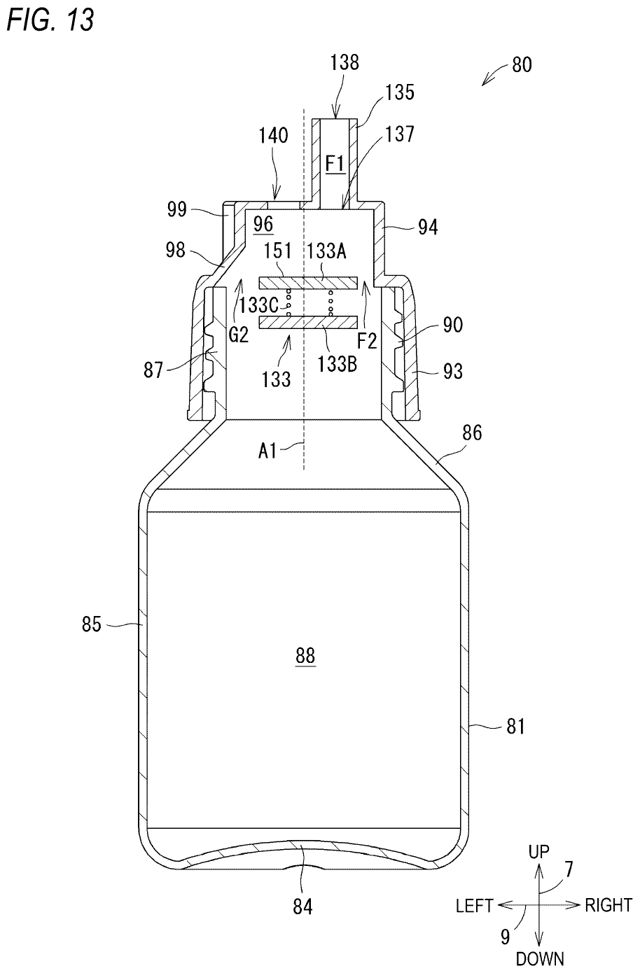

The valve 133 is movable between a close position and an open position in the up-down direction 7, which is the axis A1 direction. The close position is a position where the upper surface 151 of the valve body 133A is pressed in the upward orientation against the lower surface of the upper end wall 91 of the protrusion 94 by a biasing force of the coil spring 133C (see FIGS. 10 and 13). The valve body 133A at the close position closes the fifth opening 137 and the seventh opening 140 of the bottle-side tube body 135. The open position is a position where the valve body 133A is moved in the downward orientation from the close position against the biasing force of the coil spring 133C (see FIG. 13).

The valve 133 at the open position defines, by a left end surface of the valve body 133A and an inner surface of the inclined portion 98, an air flow path G2 through which air flows. The air flow path G2 communicates the ink storage chamber 88 with the seventh opening 140. A width of the air flow path G2 is determined by the size of the area surrounded by the left end surface of the valve body 133A and the inner surface of the inclined portion 98 in the section obtained by cutting the inclined portion 98 along the horizontal surface.

The valve 133 at the open position defines, by a right end surface of the valve body 133A and the inner surface of the protrusion 94, an ink flow path F2 (example of liquid flow path) through which ink flows. The ink flow path F2 communicates the ink storage chamber 88 with the fifth opening 137. A width of the ink flow path F2 is determined by the size of the area surrounded by the right end surface of the valve body 133A and the inner surface of the protrusion 94 in the section obtained by cutting the inclined portion 98 along the horizontal surface. The ink flow path F2 is smaller than the air flow path G2 in the left-right direction 9. In other words, the air flow path G2 is set to be larger than the ink flow path F2 by being defined by the left end surface of the valve body 133A and the inner surface of the inclined portion 98.

Connection with Ink Tank 100M of Liquid Bottle 80

First, the tank cap 127 is detached from the cover portion 122 of the ink tank 100M. Next, the protrusion 94 of the liquid bottle 80 illustrated in FIG. 8 is fitted into the rightmost through hole 72 in FIG. 5 from above. At this time, for example, when the user tries to fit the protrusion 94 into the through hole 72 other than the rightmost through hole 72 in FIG. 6, since the key member 99 does not enter the key groove 73, the liquid bottle 80 is prevented from being connected to the wrong ink tank 100.

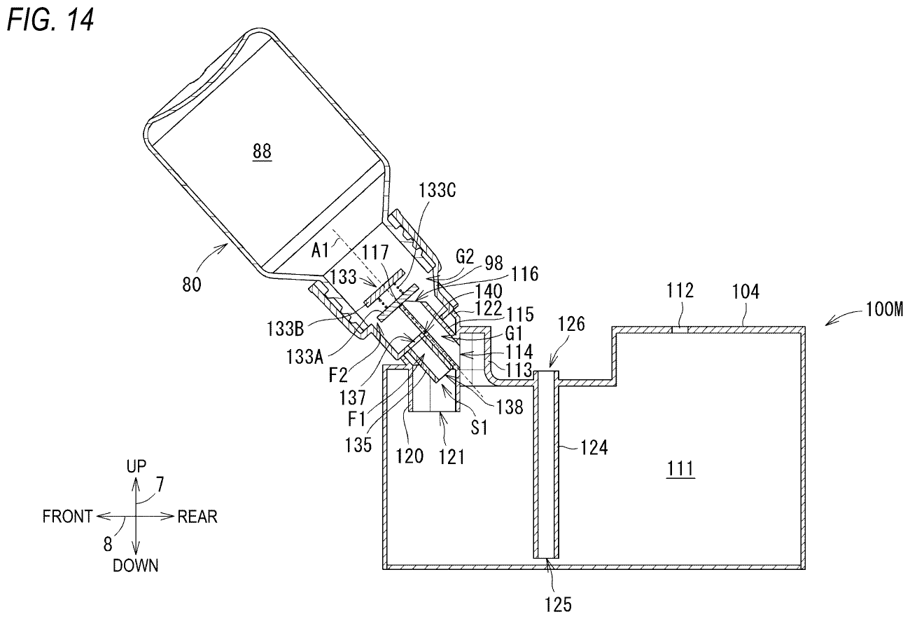

As illustrated in FIG. 14, in a state where the protrusion 94 of the liquid bottle 80 is fitted into the through hole 72, the liquid bottle 80 is held in a posture in which the bottle-side tube body 135 of the liquid bottle 80 is connected to the third opening 119 of the ink tank 100M and the tank-side tube body 115 of the ink tank 100M is inserted into the seventh opening 140 of the liquid bottle 80. At this time, the valve 133 is pressed obliquely in the upward orientation by the pressing surface 117 of the bottle-side tube body 135, thereby moving from the close position to the open position against the biasing force of the coil spring 133C. The bottle-side tube body 135 is connected to the connection tube body 120. As a result, the liquid bottle 80 is connected to the ink tank 100M, and the ink can be supplied to the inside of the ink tank 100M via the third opening 119. Hereinafter, the up-down direction 7 of the liquid bottle 80 will be described based on a supply posture when the liquid bottle 80 is connected to the ink tank 100M (posture in which protrusion 94 is fitted into through hole 72).

The bottle-side tube body 135 extends obliquely in the downward orientation along an extending direction intersecting the gravity direction and the horizontal direction. The fifth opening 137 is located below the axis A1 in a virtual section orthogonal to the axis A1. The fifth opening 137 is located at a lower end of the internal space 96 of the protrusion 94. The seventh opening 140 is located above the fifth opening 137. The bottle-side tube body 135 is located below the tank-side tube body 115. The seventh opening 140 is located above the fifth opening 137. The air flow path G2 is located above the valve 133. The air flow path G2 is located above the second opening 116. The ink flow path F2 is located below the air flow path G2.

Hereinafter, the supply of ink from the liquid bottle 80 to the ink tank 100M when the liquid bottle 80 is in the supply posture will be described. In the following description, the ink is supplied from the liquid bottle 80 to the ink tank 100M by a so-called chicken feed method.

When the liquid bottle 80 is connected to the ink tank 100M, the sixth opening 138 of the bottle-side tube body 135 is located in the ink chamber 111 of the ink tank 100, and the second opening 116 of the tank-side tube body 115 is located in the internal space 96 of the protrusion 94 in the liquid bottle 80. Further, when the valve 133 is located at the open position, the air flow path G2 and the ink flow path F2 that communicate the ink storage chamber 88 with the internal space 96 of the protrusion 94 are formed. As a result, the ink storage chamber 88 of the liquid bottle 80 and the ink chamber 111 of the ink tank 100M communicate with each other through the ink flow path F2, the ink flow path F1, the auxiliary ink flow path S1, the air flow path G2, and the air flow path G1. Accordingly, the ink stored in the ink storage chamber 88 flows to the ink chamber 111 via the ink flow path F2, the ink flow path F1, and the auxiliary ink flow path S1. In addition, when the ink flows, the air enters the ink chamber 111 from the air communication port 112, and flows into the ink storage chamber 88 via the air flow path G1 and the air flow path G2. Here, a volume of the ink flowing from the ink storage chamber 88 to the ink chamber 111 is substantially the same as a volume of the air flowing from the ink chamber 111 to the ink storage chamber 88. In this way, so-called air-liquid replacement is performed. When all the ink in the ink storage chamber 88 of the liquid bottle 80 flows out to the ink chamber 111 of the ink tank 100, the air-liquid replacement ends. Finally, the liquid bottle 80 is detached from the ink tank 100M, and the tank cap 127 is attached to the cover portion 122 of the ink tank 100M.

### Operation and Effect of Embodiment

In the liquid bottle 80, the region 215 serving as the fifth opening 137 and the seventh opening 140 is asymmetric in the left-right direction 9 with respect to the axis A1 in the virtual section orthogonal to the axis A1. Therefore, when the valve 133 that closes the fifth opening 137 and the seventh opening 140 moves from the close position to the open position, a wide space and a narrow space are easily defined between the valve 133 at the open position and the inner surface of the bottle body 81 in the left-right direction 9. Since the flow path resistance of the fluid is reduced in the wide space, the air easily flows. Therefore, when the liquid bottle 80 is connected to the ink tank 100M, air-liquid exchange is smoothly performed in which ink and air move between the liquid bottle 80 and the ink tank 100M.

In the liquid bottle 80, the region 215 serving as the fifth opening 137 and the seventh opening 140 is eccentric in the rightward orientation with respect to the axis A1, and the upper surface 151 on which the valve 133 closes the fifth opening 137 and the seventh opening 140 is eccentric in the rightward orientation with respect to the axis A1. Therefore, while the valve 133 at the close position more reliably closes the fifth opening 137 and the seventh opening 140, a wider space is easily defined between the valve 133 at the open position and the inner surface of the bottle body 81.

In the liquid bottle 80, since the air flow path is formed between the valve 133 at the open position and the inner surface of the inclined portion 98, the flow of air is less likely to stagnate in the internal space 96 of the protrusion 94.

In the liquid bottle 80, since the ink in the ink storage chamber 88 flows out of the liquid bottle 80 from the fifth opening 137 through the ink flow path F2, air-liquid replacement is smoothly implemented in the liquid bottle 80.

The multi function device 10 includes the liquid bottle 80, the ink tank 100 having the third opening 119, and the through hole 72 located around the third opening 119, and the liquid bottle 80 is held in a posture capable of supplying ink to the inside of the ink tank 100 via the third opening 119 in a state where the bottle cap 82 is fitted into the through hole 72. Therefore, convenience in supplying the ink from the liquid bottle 80 to the ink tank 100 is improved.

In the multi function device 10, the bottle cap 82 has the key member 99 protruding in an orientation intersecting the axis A1, the through hole 72 has the key groove 73 cut out in a groove shape, and the key member 99 is fitted into the key groove 73. Since the outer peripheral surface of the bottle cap 82 conforms to the inner surface of the through hole 72, the bottle cap 82 functions as a key. Therefore, an appropriate liquid bottle 80 is inserted into the ink tank 100.

In the multi function device 10, the protrusion 94 of the bottle cap 82 having the key member 99 in FIG. 8 has a shape that may be fitted, from above, into the through hole 72 having the key groove 73 located on the rightmost side in FIG. 6. On the other hand, the protrusion 94 of the bottle cap 82 having the key member 99 in FIG. 8 does not enter the through hole 72 other than the through hole 72 having the key groove 73, which is located on the rightmost side in FIG. 6. Therefore, the liquid bottle 80 is inserted into the appropriate third opening 119 with respect to the ink tank 100 having a plurality of third openings 119. For example, the liquid bottle 80 storing ink of a color other than yellow (Y) is prevented from being inserted into the third opening 119 of the ink tank 100Y.

In the liquid bottle 80, the region 215 serving as the seventh opening 140 and the fifth opening 137 is eccentric in the rightward orientation with respect to the axis A1, and the seventh opening 140 and the fifth opening 137 are located in opposite orientations with respect to the axis A1, so that the air-liquid exchange is performed more smoothly.

In the liquid bottle 80, the distance L1 between the center C2 of the fifth opening 137 and the axis A1 is larger than the distance L2 between the center C1 of the seventh opening 140 and the axis A1. Therefore, the air flow path G2 defined by the left end surface of the valve body 133A of the valve 133 at the open position and the inner surface of the inclined portion 98 is larger in the left-right direction 9 than in a case where the upper end portion of the protrusion 94 is not eccentric with respect to the axis A1 (case where center A2 of protrusion 94 coincides with axis A1). Therefore, the air-liquid replacement is more smoothly implemented in the liquid bottle 80.

In the liquid bottle 80, since the valve 133 at the close position closes the seventh opening 140 and the fifth opening 137, the configuration of the valve 133 is simple compared to a case where a valve that closes the seventh opening 140 and a valve that closes the fifth opening 137 are separately provided inside the bottle body 81. In addition, the valve 133 can be easily moved from the close position to the open position by the tank-side tube body 115 inserted into the bottle body 81 through the seventh opening 140.

In the liquid bottle 80, the bottle cap 82 has the protrusion 94 extending in the direction in which the axis A1 extends and having the seventh opening 140 and the fifth opening 137, and the protrusion 94 has a shape that is not rotationally symmetrical when viewed in the direction in which the axis A1 extends. Therefore, for example, when the inner surface of the through hole 72 has a shape conforming to the shape of the protrusion 94, the orientation in which the protrusion 94 is fitted into the through hole 72 is determined to be one.

In the liquid bottle 80, the protrusion 94 has the key member 99 protruding from the outer peripheral surface of the protrusion 94 in the orientation intersecting the axis A1. For example, the protrusion 94 having the key member 99 in FIG. 8 has a shape that may be fitted, from above, into the through hole 72 having the key groove 73, which is located on the rightmost side in FIG. 6. On the other hand, the protrusion 94 having the key member 99 in FIG. 8 does not enter the through hole 72 other than the through hole 72 having the key groove 73, which is located on the rightmost side in FIG. 6. Therefore, the liquid bottle 80 is inserted into the appropriate third opening 119 with respect to the ink tank 100 having a plurality of third openings 119. For example, the liquid bottle 80 storing ink of a color other than yellow (Y) is prevented from being inserted into the third opening 119 of the ink tank 100Y.

In the liquid bottle 80, the bottle cap 82 includes the bottle-side tube body 135, which is connected to the fifth opening 137 and extends in an orientation in which the valve 133 moves from the open position to the close position. Due to a water head difference, the air-liquid exchange starts smoothly.

The multi function device 10 includes the liquid bottle 80 and the ink tank 100 having the third opening 119. The ink tank 100 includes the tank-side tube body 115 that communicates the inside and the outside of the ink tank 100. In the connection state where the liquid bottle 80 is connected to the ink tank 100, the bottle-side tube body 135 is connected to the third opening 119, and the tank-side tube body 115 is inserted into the bottle body 81 of the liquid bottle 80 through the seventh opening 140 to hold the valve 133 at the open position. Since the air easily flows into the air flow path through the tank-side tube body 115, the air-liquid exchange starts smoothly.

In the multi function device 10, the fifth opening 137 is located at the lower end of the protrusion 94 of the bottle body 81 in the internal space 96 in the state where the liquid bottle 80 is connected to the ink tank 100. Therefore, the ink is less likely to remain in the vicinity of the fifth opening 137 of the internal space 96 of the protrusion 94.

The multi function device 10 includes the through hole 72 located around the third opening 119 and having a shape conforming to the protrusion 94. The tank-side tube body 115 extends in an extending direction intersecting the gravity direction and the horizontal direction. In a state where the protrusion 94 is fitted into the through hole 72, the liquid bottle 80 is held in a connection state in a posture in which the axis A1 is along the extending direction. In the virtual section in the connection state where the liquid bottle 80 is connected to the ink tank 100, the fifth opening 137 is located below the axis A1, and the seventh opening 140 is located above the fifth opening 137. Since the air flow path G2 is located above the valve 133, air easily flows into the ink storage chamber 88 through the air flow path G2. On the other hand, since the ink flow path F2 is located below the air flow path G2, the ink easily flows out from the fifth opening 137 through the ink flow path F2.

In the multi function device 10, the tank cap 127 closes the second opening 116 and the third opening 119 of the tank-side tube body 115 in a state of being attached to the cover portion 122. Therefore, the tank cap 127 prevents a foreign matter such as dust from entering the ink tank 100M through the tank-side tube body 115 and the third opening 119 and prevents ink from leaking from the ink tank 100M.

### MODIFICATIONS

The fifth opening 137 and the seventh opening 140 are circular, but are not limited to circular as long as air-liquid exchange can be performed between the liquid bottle 80 and the ink tank 100M through the fifth opening 137 and the seventh opening 140. For example, the fifth opening 137 and the seventh opening 140 may be triangular or quadrangular. In this case, the bottle-side tube body 135 connected to the fifth opening 137 has a triangular shape in a section orthogonal to a tube axis thereof. The tank-side tube body 115 inserted into the seventh opening 140 has a triangular shape in a section orthogonal to the tube axis 115A thereof.

The protrusion 94 includes the inclined portion 98 that is inclined such that the internal space 96 of the protrusion 94 extends in the leftward orientation as it goes downward, but the inclined portion 98 may be omitted. In other words, the center A2 of the upper end portion of the protrusion 94 may coincide with the axis A1 of the third side wall 87. In this case, the region 215 serving as the seventh opening 140 and the fifth opening 137 are asymmetric with respect to the center A2 (axis A1) in a virtual section orthogonal to the axis A1 in the upper end wall 91 of the protrusion 94. For example, a center of a line segment connecting the center C1 of the seventh opening 140 and the center C2 of the fifth opening 137 may be deviated rightward with respect to the center A2 of the protrusion 94. In this case, the center C3 of the valve 133 may be deviated rightward with respect to the center A2 of the protrusion 94.

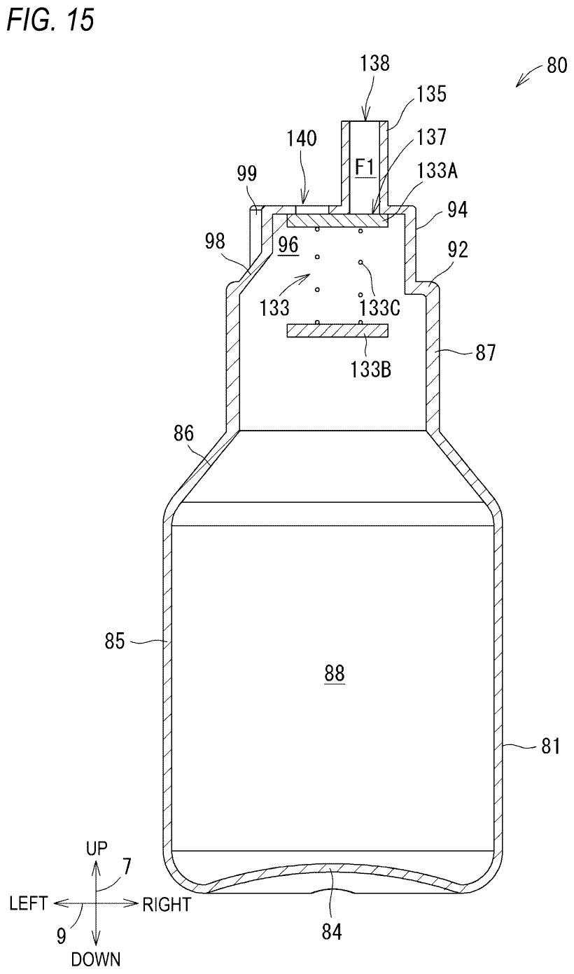

The third side wall 87 and the bottle cap 82 are separately formed, but may be integrally formed as illustrated in FIG. 15. In this case, the fourth side wall 93 of the bottle cap 82 may be omitted. The bottle body 81 in which the third side wall 87 and the bottle cap 82 are integrally formed is an example of the body. A side of the bottle body 81 in which the third side wall 87 and the bottle cap 82 are integrally formed, on which the fifth opening 137 and the seventh opening 140 communicate with each other, is an example of the port portion.

The through hole 72 into which the protrusion 94 is fitted is formed in the holding member 110, but may be formed in the upper wall 104 of the ink tank 100M or may be omitted. In this case, the holding member 110 may be omitted.

Although the bottle cap 82 includes the key member 99, the key member 99 may be omitted. In this case, the key groove 73 into which the key member 99 is fitted may also be omitted.

The orientation in which the key member 99 protrudes is rightward orientation, but is not particularly limited as long as the orientation intersects the axis A1.

The center C3 of the upper surface 151 of the valve 133 in the left-right direction 9 coincides with the center A2 of the upper end portion of the protrusion 94, but may not coincide with the center A2 as long as the center C3 is located to the right of the axis A1.

The valve 133 at the open position defines, between the valve 133 and the inner surface of the protrusion 94, the ink flow path F2 communicating the fifth opening 137 with the ink storage chamber 88, but the ink flow path F2 may be omitted. In this case, the ink in the ink storage chamber 88 flows to the outside of the liquid bottle 80 from the fifth opening 137 through a part of the air flow path G2.

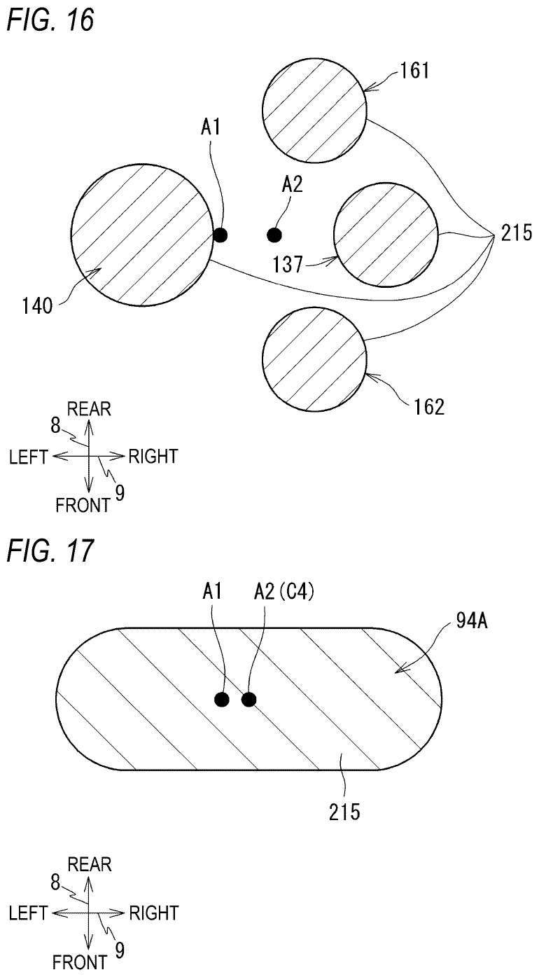

Although the fifth opening 137 and the seventh opening 140 are provided as the communication ports communicating the inside and the outside of the bottle body 81, one or more openings may be further provided as long as the region 215 serving as the communication port in the virtual section orthogonal to the axis A1 is asymmetric with respect to the axis A1. For example, an eighth opening and a ninth opening may be further provided at the upper end of the protrusion 94, as illustrated in FIG. 16. An eighth opening 161 is located behind the fifth opening 137 on the right side of the axis A1. A tube body inserted into the ink chamber 111 of the ink tank 100M may be connected to the eighth opening 161, and a tube body provided in the ink tank 100M may be inserted into the eighth opening 161. A ninth opening 162 is located in front of the fifth opening 137 on the right side of the axis A1. A tube body inserted into the ink chamber 111 of the ink tank 100M may be connected to the ninth opening 162, and a tube body provided in the ink tank 100M may be inserted into the ninth opening 162. In this case, in order to easily provide the eighth opening 161 and the ninth opening 162 at the upper end of the protrusion 94, the protrusion 94 may have a circular outer shape when viewed from above.

Although the valve 133 closes the fifth opening 137 and the seventh opening 140 at the close position, for example, a valve that closes the fifth opening 137 and a valve that closes the seventh opening 140 may be provided instead of the valve 133.

In the state where the liquid bottle 80 is connected to the ink tank 100, the fifth opening 137 is located at the lower end of the protrusion 94 in the internal space 96, but may be located above the lower end of the protrusion 94 in the internal space 96.

The liquid bottle 80 includes the bottle-side tube body 135 that defines the ink flow path F1, but the bottle-side tube body 135 may be omitted. In this case, a tube body that defines the ink flow path F1 is provided in the ink tank 100M. The tube body defining the ink flow path F1 may be inserted into the internal space 96 of the protrusion 94 through the fifth opening 137. Further, one upper end opening 94A that is opened in the upper surface of the upper end wall 91 of the protrusion 94 may be provided instead of the fifth opening 137 and the seventh opening 140. In this case, when the liquid bottle 80 is connected to the ink tank 100M, the tube body defining the tank-side tube body 115 and the ink flow path F1 is inserted into the internal space 96 of the protrusion 94 through the upper end opening 94A of the protrusion 94. A center C4 of the upper end opening 94A in the left-right direction 9 coincides with the center A2 of the upper end portion of the protrusion 94. In other words, the upper end opening 94A is eccentric in the rightward orientation with respect to the axis A1, as illustrated in FIG. 17. In other words, the region 215 serving as the upper end opening 94A in the virtual section orthogonal to the axis A1 is asymmetric in the left-right direction 9 with respect to the axis A1. The upper end opening 94A is an example of the communication port.

The tank-side tube body 115 extends obliquely in the upward orientation from the first opening 114 of the upper bulging portion 113 in the ink tank 100M along the extending direction intersecting the gravity direction and the horizontal direction, but may extend in the upward orientation along the gravity direction. In this case, the first opening 114 is formed at the upper end of the upper bulging portion 113, for example. When the liquid bottle 80 is connected to the ink tank 100M, the bottle-side tube body 135 is inserted into the third opening 119 along the gravity direction.

The tank cap 127 that closes the second opening and the third opening of the tank-side tube body 115 in the state of being attached to the cover portion 122 is provided, but the tank cap 127 may be omitted.

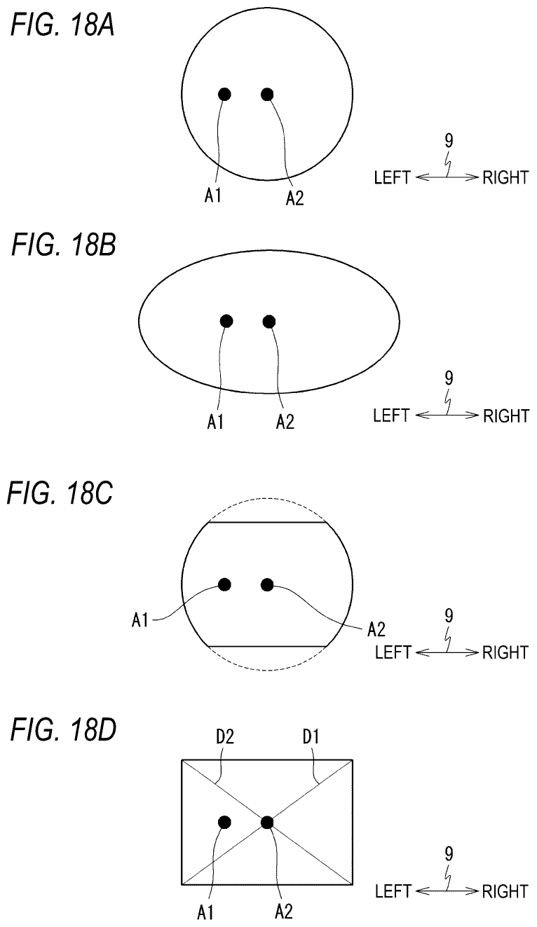

The inner peripheral surface at the upper end portion of the protrusion 94 has a shape in which two virtual circles S1 and S2 are connected by two parallel tangents, but is not particularly limited as long as the center A2 at the upper end portion of the protrusion 94 is deviated from the axis A1. For example, the shape drawn by the inner peripheral surface at the upper end portion of the protrusion 94 may be circular in a section obtained by cutting the upper end portion of the protrusion 94 along a horizontal surface, as illustrated in FIG. 18A. In this case, the center A2 of the upper end portion of the protrusion 94 is located at the center of the circle drawn by the inner peripheral surface of the upper end portion of the protrusion 94 in the section.

The inner peripheral surface of the upper end portion of the protrusion 94 may be elliptical in the section, as illustrated in FIG. 18B. In this case, the center A2 of the upper end portion of the protrusion 94 is located at the center of the ellipse drawn by the inner peripheral surface of the upper end portion of the protrusion 94 in the section.

The inner peripheral surface of the upper end portion of the protrusion 94 may have a shape in which a portion of a circle in the section is cut out, as illustrated in FIG. 18C. In this case, the center A2 of the upper end portion of the protrusion 94 is located at the center of the virtual circle that compensates for the cutout portion in the section.

The inner peripheral surface of the upper end portion of the protrusion 94 may be rectangular in the section, as illustrated in FIG. 18D. In this case, the center A2 of the upper end portion of the protrusion 94 may be located at an intersection of two diagonal lines D1 and D2 of the rectangle in the section.

Although the ink has been described as an example of the recording liquid, the present invention is not limited thereto. That is, instead of the ink, a pretreatment liquid to be ejected to the sheet prior to the ink during printing, water to be sprayed in the vicinity of the nozzle 40 of the recording head 39 to prevent the nozzle 40 of the recording head 39 from drying, or the like may be an example of the recording liquid.

According to the present specification, a system and a liquid container according to the following aspects are provided.

(1) A liquid container according to the present disclosure includes a body including a port portion defining an opening of a storage chamber configured to store a recording liquid, and a valve located inside the body. The port portion includes a communication port that communicates the storage chamber with outside. The valve is movable in an axial direction in which an axis of the port portion extends, between a close position where the communication port is closed and an open position where the communication port is opened. A region serving as the communication port in a virtual section orthogonal to the axis is asymmetrical with respect to the axis.

Since in the virtual section, the region serving as the communication port is asymmetric with respect to the axis of the body, a wide space and a narrow space are easily defined between the valve at the open position and an inner surface of the body when the valve that closes the communication port moves from the close position to the open position. Since the flow path resistance of the fluid is reduced in the wide space, the air easily flows. Therefore, when the liquid container is connected to the tank, air-liquid exchange is smoothly performed in which the recording liquid and the air move back and forth between the liquid container and the tank.

(2) The region serving as the communication port may be eccentric in an eccentric orientation with respect to the axis, and a surface on which the valve closes the communication port may be eccentric in the eccentric orientation with respect to the axis.

Since the region serving as the communication port and the surface on which the valve closes the communication port are eccentric in the same eccentric orientation with respect to the axis, the valve at the close position more reliably closes the communication port, and a wider space is easily defined between the valve at the open position and the inner surface of the body.

(3) The valve at the open position may define, between the valve and an inner surface of the body, an air flow path that communicates the communication port with the storage chamber.

Since the air flow path is formed between the valve at the open position and the inner surface of the body, the flow of air is less likely to stagnate inside the body of the liquid container.

(4) The valve at the open position may define, between the valve and the inner surface of the body, a liquid flow path that communicates the communication port with the storage chamber.

Since the liquid in the storage chamber flows out of the liquid container from the communication port through the liquid flow path, air-liquid replacement is smoothly implemented in the liquid container.

(5) The port portion may include a container cap having the communication port, and an attachment portion to which the container cap is attached.

(6) A system according to the present disclosure may include the liquid container; a tank including a supply port; and a through hole located around the supply port, in which the liquid container may be held in a posture allowing a recording liquid to be supplied into the tank through the supply port in a state where the port portion is fitted into the through hole.

(7) The port portion may include a key portion protruding in an orientation intersecting the axis. The through hole may include a key groove cut out in a groove shape. The key portion may be fitted into the key groove.

Since the key groove matches the outer shape of the key portion, the liquid container is connected to an appropriate supply port with respect to a tank having a plurality of supply ports.

(8) The region serving as the communication port may be eccentric in an eccentric orientation with respect to the axis. The communication port may include a first communication port located in an orientation opposite to the eccentric orientation with respect to the axis, and a second communication port located in the eccentric orientation with respect to the axis.

Since the first communication port and the second communication port are located in opposite orientations with respect to the axis, the air-liquid exchange is performed more smoothly.

(9) A distance between the second communication port and the axis may be larger than a distance between the first communication port and the axis.

The flow path communicating with the first communication port can be made larger.

(10) The valve at the close position may close the first communication port and the second communication port.

The configuration of the valve is simplified.

(11) The port portion may include a protrusion extending in the axial direction and including the first communication port and the second communication port. The protrusion may have a shape that is not rotationally symmetric when viewed in the axial direction.

(12) The protrusion may include a key portion protruding from an outer peripheral surface of the protrusion in an orientation intersecting the axis.

(13) An orientation in which the key portion protrudes may be an orientation opposite to the eccentric orientation toward a position farthest from the axis in the region serving as the communication port in the virtual section.

(14) The port portion may include a first tube body connected to the second communication port and extending in an orientation in which the valve moves from the open position to the close position.

Due to a water head difference, the air-liquid exchange starts smoothly.

(15) A system according to the present disclosure may include the liquid container and a tank including a supply port, in which the tank may include a second tube body that communicates inside and outside of the tank. In a connection state where the liquid container is connected to the tank, the first tube body may be connected to the supply port, and the second tube body may be inserted into the body of the liquid container through the first communication port to hold the valve at the open position.

Since the air easily flows into the air flow path through the second tube body, the air-liquid exchange starts smoothly.

(16) In the connection state, the second communication port may be located at a lower end inside the body.

The recording liquid is less likely to remain in the vicinity of the second communication port inside the body.

(17) A through hole located around the supply port and having a shape conforming to the protrusion may be provided. The second tube body may extend in an extending direction intersecting a gravity direction and a horizontal direction. The liquid container may be held in the connection state in a posture in which the axis is along the extending direction in a state where the protrusion is fitted into the through hole. The second communication port may be located below the axis and the first communication port may be located above the second communication port in the virtual section in the connection state.

Since in the connection state, the first communication port located in the orientation opposite to the eccentric orientation with respect to the axis is located above the second communication port located in the eccentric orientation with respect to the axis, air easily flows into the storage chamber of the liquid container through the second tube body inserted into the first communication port, and the recording liquid easily flows out from the second communication port through the first tube body.

(18) The tank may include a cover portion configured to cover the second tube body and a periphery of the supply port, and a tank cap configured to be attached to and detached from the cover portion. The tank cap may close a distal end opening of the second tube body and the supply port in a state where the tank cap is attached to the cover portion.

The tank cap prevents a foreign matter such as dust from entering the tank through the second tube body and the supply port and prevents liquid from leaking from the tank.

(19) A liquid container according to the present disclosure includes a body including a port portion defining an opening of a storage chamber configured to store a recording liquid, and a valve located inside the body. The port portion includes a first communication port and a second communication port that communicate the storage chamber with outside. The valve is movable in an axial direction in which an axis of the port portion extends, between a close position where the first communication port and the second communication port are closed and an open position where the first communication port and the second communication port are opened. A first distance between the second communication port and the axis is larger than a second distance between the first communication port and the axis.

Since the first distance between the second communication port and the axis is larger than the second distance between the first communication port and the axis, a wide space and a narrow space are defined between the valve at the open position and the inner surface of the body when the valve that closes the first communication port and the second communication port moves from the close position to the open position. Since the flow path resistance of the fluid is reduced in the wide space, the air easily flows. Therefore, when the liquid container is connected to the tank, air-liquid exchange is smoothly performed in which the recording liquid and the air move back and forth between the liquid container and the tank.

With the liquid container and the system, air-liquid exchange is smoothly performed in which the recording liquid and the air move back and forth between the liquid container and the tank.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A liquid container comprising:
a body including a port portion defining an opening of a storage chamber configured to store a recording liquid; and
a valve located inside the body, wherein
the port portion includes a communication port that communicates the storage chamber with outside,
the valve is movable in an axial direction in which an axis of the port portion extends, between a close position where the communication port is closed and an open position where the communication port is opened, and
a region serving as the communication port in a virtual section orthogonal to the axis is asymmetrical with respect to the axis.

2. The liquid container according to claim 1, wherein
the region serving as the communication port is eccentric in an eccentric orientation with respect to the axis, and
a surface on which the valve closes the communication port is eccentric in the eccentric orientation with respect to the axis.

3. The liquid container according to claim 2, wherein
the valve at the open position defines, between the valve and an inner surface of the body, an air flow path that communicates the communication port with the storage chamber.

4. The liquid container according to claim 3, wherein
the valve at the open position defines, between the valve and the inner surface of the body, a liquid flow path that communicates the communication port with the storage chamber.

5. The liquid container according to claim 1, wherein
the port portion includes a container cap including the communication port, and an attachment portion to which the container cap is attached.

6. A system comprising:
the liquid container according to claim 1;
a tank including a supply port; and
a through hole located around the supply port, wherein
the liquid container is held in a posture allowing a recording liquid to be supplied into the tank through the supply port in a state where the port portion is fitted into the through hole.

7. The system according to claim 6, wherein
the port portion includes a key portion protruding in an orientation intersecting the axis,
the through hole includes a key groove cut out in a groove shape, and
the key portion is fitted into the key groove.

8. The liquid container according to claim 1, wherein
the region serving as the communication port is eccentric in an eccentric orientation with respect to the axis, and
the communication port includes a first communication port located in an orientation opposite to the eccentric orientation with respect to the axis and a second communication port located in the eccentric orientation with respect to the axis.

9. The liquid container according to claim 8, wherein
a distance between the second communication port and the axis is larger than a distance between the first communication port and the axis.

10. The liquid container according to claim 8, wherein
the valve at the close position closes the first communication port and the second communication port.

11. The liquid container according to claim 8, wherein
the port portion includes a protrusion extending in the axial direction and including the first communication port and the second communication port, and
the protrusion has a shape that is not rotationally symmetric when viewed in the axial direction.

12. The liquid container according to claim 11, wherein
the protrusion includes a key portion protruding from an outer peripheral surface of the protrusion in an orientation intersecting the axis.

13. The liquid container according to claim 12, wherein
the orientation in which the key portion protrudes is an orientation opposite to the eccentric orientation toward a position farthest from the axis in the region serving as the communication port in the virtual section.

14. The liquid container according to claim 11, wherein
the port portion includes a first tube body connected to the second communication port and extending in an orientation in which the valve moves from the open position to the close position.

15. A system comprising:
the liquid container according to claim 14; and
a tank including a supply port, wherein
the tank includes a second tube body that communicates inside and outside of the tank, and
in a connection state where the liquid container is connected to the tank,
the first tube body is connected to the supply port, and
the second tube body is inserted into the body of the liquid container through the first communication port to hold the valve at the open position.

16. The system according to claim 15, wherein
in the connection state, the second communication port is located at a lower end inside the body.

17. The system according to claim 15, further comprising:
a through hole located around the supply port and having a shape conforming to the protrusion, wherein
the second tube body extends in an extending direction intersecting a gravity direction and a horizontal direction,
the liquid container is held in the connection state in a posture in which the axis is along the extending direction in a state where the protrusion is fitted into the through hole, and
the second communication port is located below the axis and the first communication port is located above the second communication port in the virtual section in the connection state.

18. The system according to claim 15, wherein
the tank includes
a cover portion configured to cover the second tube body and a periphery of the supply port, and
a tank cap configured to be attached to and detached from the cover portion, and
the tank cap closes a distal end opening of the second tube body and the supply port in a state where the tank cap is attached to the cover portion.

19. A liquid container comprising:
a body including a port portion defining an opening of a storage chamber configured to store a recording liquid; and
a valve located inside the body, wherein
the port portion includes a first communication port and a second communication port that communicate the storage chamber with outside,
the valve is movable in an axial direction in which an axis of the port portion extends, between a close position where the first communication port and the second communication port are closed and an open position where the first communication port and the second communication port are opened, and
a first distance between the second communication port and the axis is larger than a second distance between the first communication port and the axis.
